(19) United States
(12) Patent Application Publication
(10) Pub. No.: US 2011/0006178 A1
(43) Pub. Date: Jan. 13, 2011

(54) HANG-ON DEVICE MOUNTING STRUCTURE

(75) Inventor: Chuan-Yu CHENG, Taipei City (TW)

Correspondence Address: Muncy, Geissler, Olds & Lowe, PLLC, 4000 Legato Road, Suite 310, FAIRFAX, VA, 22033, US

(73) Assignee: NICHE SUMMIT CO., LTD.

(21) Appl. No.: 12/554,507

(22) Filed: Sep. 4, 2009

(30) Foreign Application Priority Data
Jul. 13, 2009 (TW) 098212742

(51) Int. Cl. A47B 96/06; F16B 47/00; A44B 11/25; A44B 18/00

(52) U.S. Cl. 248/213.2; 248/205.1; 248/205.3; 24/163 R; 24/442

(57) ABSTRACT

A hang-on device mounting structure for securing a hang-on device to a motorcycle or bicycle to avoid interference of the hang-on device with the vehicle rider is disclosed to include one or multiple base panels mounted in a toolbox or luggage-carrier of a motorcycle or bicycle, each base panel having one or a number of positioning units, and one of a number of connection devices for securing a hang-on device to the base panel(s), each connection device has a mounting member for fastening to one positioning unit of one base panel, a connector connectable to one matching connector of the hang-on device and an extension member connected between the mounting member and the connector.

This application claims the priority benefit of Taiwan patent application number 098212742 filed on Jul. 13, 2009

### BACKGROUND OF THE INVENTION

1. Field of the Invention

The present invention relates to a hang-on device mounting arrangement and more particularly, to a hang-on device mounting structure for securing a hang-on device to a two-wheel vehicle to avoid interference of the hang-on device with the vehicle ride.

2. Description of the Related Art

When going outdoors, one may carry many personal items such as purse, pen, notebook, cell phone, bunch of keys, eyeglasses, water bottle and etc. A woman may also carry cosmetic bag, facial tissue and other makeup accessories. These personal items may be carried in a backpack, shoulder bade, carry-on bag, suitcase, water bottle, safety helmet or sea bag. Further, a person may use a travel bag or sports bag to carry personal items, sports wear or sports gear. Further, some people may take a bus or public transportable vehicle when going to the office or going home after work. Some other people may use a two-wheel vehicle, for example, motorcycle or bicycle, as one's personal transportation vehicle. When riding a two-wheel vehicle, one may carry a water bottle, sports gear and some other personal items in a bag, and put the bag on the back or hang the bag on the two-wheel vehicle. During riding, the bag may swing, interfering with movement of the rider's body. To avoid swinging of the bag, the rider may put the bag in the toolbox of the two-wheel vehicle or fasten the bag to the luggage-carrier of the two-wheel vehicle. However, if the bag is too big to be put in the toolbox of the two-wheel vehicle or fastened to the luggage-carrier of the two-wheel vehicle or hung on the rider's back, the rider may hang the bag on the top tube between the saddle and head tube of the two-wheel vehicle or put the bag on the front footrest of the two-wheel vehicle.

When carrying a bag on the back as one is riding a motorcycle or bicycle, the bag may swing, causing a dynamic drag force that hinders movement of the rider's body. If the rider stops the motorcycle or bicycle suddenly, the effect of inertia will force the bag and the storage items forwards, affecting riding safety.

When carrying a bag on the front footrest of a motorcycle or bicycle or hanging a bag on the front side of the motorcycle or bicycle as one is riding the motorcycle or bicycle, the bag may hinder resting of the rider's legs on the front footrest. When moving the motorcycle or bicycle forwards after the green traffic light is on, the rider may forget the presence of the bag on the front footrest and may step the legs on the bag directly. In order not to step on the bag that is put in the front footrest of the motorcycle, the rider may have to suspend the legs outside the motorcycle. Suspending the legs outside the motorcycle affects riding safety.

Accordingly, there is a strong need for a measure, which allows carrying of a hang-on device on a two-wheel vehicle without affecting vehicle riding safety.

### SUMMARY OF THE INVENTION

The present invention has been accomplished under the circumstances in view. It is one object of the present invention to provide a hang-on device mounting structure, which enables a hang-on device to be conveniently detachably secured to a two-wheel vehicle without affecting vehicle riding safety.

To achieve this and other objects of the present invention, a hang-on device mounting structure comprises at least one base panel, each base panel having at least one positioning unit, and at least one connection device for securing a hang-on device to the at least one base panel. Each connection device comprises a mounting member for fastening to one positioning unit of one base panel, a connector for the connection of one matching connector of the hang-on device, and an extension member connected between the mounting member and the connector. By means of mounting the at least one base panel in the toolbox of a motorcycle or the luggage-carrier of a bicycle, the hang-on device mounting structure can secure a hang-on device, such as backpack, shoulder bade, carry-on bag, suitcase, water bottle, safety helmet or sea bag, to the motorcycle or bicycle without affecting motorcycle or bicycle riding safety.

Further, the connector of each connection device can be a male fastening member or female fastening member, and each matching connector of the hang-on device can be a female fastening member or male fastening member for fastening to the male fastening member of female fastening member of the connector of one respective connection device. A male fastening member can be a male buckle member, hook member, stud or tape of hook materials. A female fastening member can be a female buckle member, eye member, socket or tape of loop materials for the fastening of the male buckle member, hook member, stud or tape of hook materials.

Further, each base panel of the hang-on device mounting structure can be made having multiple positioning units for the connection of multiple connection devices, and the connectors of the connection devices that are connected to one base panel can be male fastening members or female fastening members of different designs for securing the hang-on device in place and keeping the hang-on device in shape.

Further, two base panels can be bilaterally mounted in the toolbox of a motorcycle or affixed to the luggage-carrier of a bicycle so that the connection devices that are respectively connected to the two base panels can secure a hang-on device firmly on the top side of the seat of the motorcycle that covers the toolbox or the top side of the luggage-carrier of the bicycle.

### BRIEF DESCRIPTION OF THE DRAWINGS

FIG. 1 is an exploded view of a hang-on device mounting structure in accordance with a second embodiment of the present invention.

FIG. 2 is an elevational assembly view of the hang-on device mounting structure shown in FIG. 1.

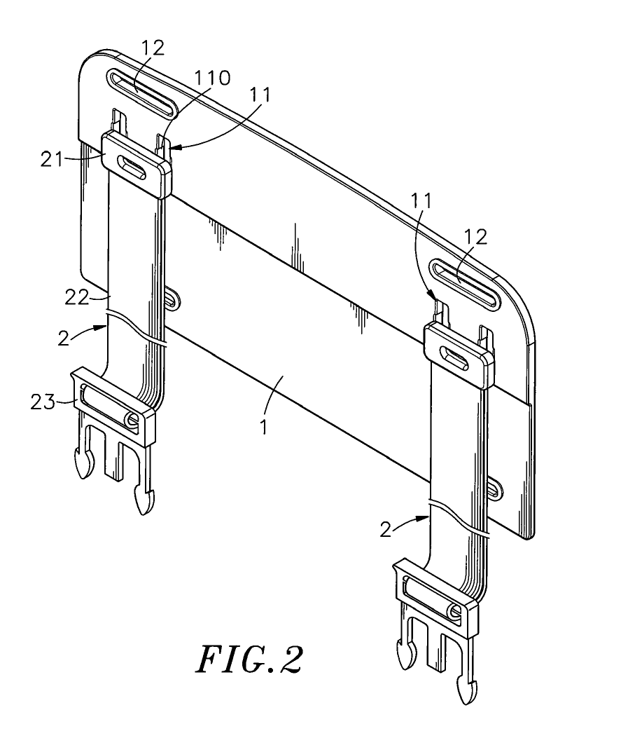

FIG. 3 is a sectional side view of the present invention, showing a mounting example of the base panel of the hang-on device mounting structure in a toolbox of a vehicle.

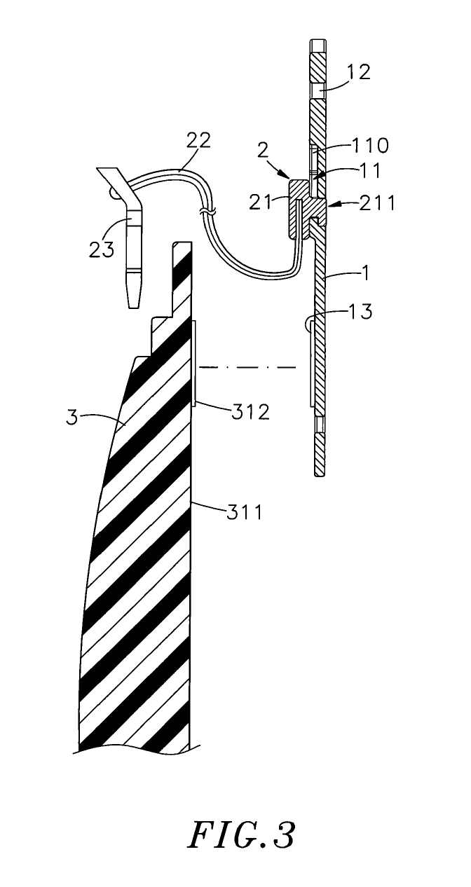

FIG. 4 is an applied view of the present invention, showing the base panel of the hang-on device mounting structure installed in a toolbox of a vehicle and a hang-on device fastened to the connectors of the connection devices of the hang-on device mounting structure outside the toolbox.

FIG. 5 illustrates each base panel of the hang-on device mounting structure provided with a first fastening element for connection to a respective second fastening element inside a toolbox of a vehicle and belt members connected between the two base panels of the hang-on device mounting structure.

FIG. 6 is a schematic drawing of the present invention, showing the connectors of the connection devices suspending outside the seat of a vehicle for the connection of matching connectors of a hang-on device.

FIG. 7 is a schematic sectional side view of the present invention, showing the hang-on device mounting structure installed in a toolbox of a vehicle and the matching connectors of a hang-on device respectively fastened to the connectors of the connection devices of the hang-on device mounting structure.

FIG. 8 is a schematic drawing of the present invention, showing another application example of the present invention where the hang-on device mounting structure is installed in a luggage-carrier of a bicycle for securing a seat cushion of hang-on device on the luggage-carrier.

FIG. 9 is a perspective view of an alternate form of the hang-on device mounting structure in accordance with the present invention.

FIG. 10 is a perspective view of another alternate form of the hang-on device mounting structure in accordance with the present invention.

FIG. 11 is an exploded view of still another alternate form of the hang-on device mounting structure in accordance with the present invention.

FIG. 12 is a perspective view of still another alternate form of the hang-on device mounting structure in accordance with the present invention.

FIG. 13 is a sectional side view of the present invention, showing a mounting example of the base panel of the hang-on device mounting structure of FIG. 11 in a toolbox of a vehicle.

FIG. 14 is a perspective view of the present invention, showing the hang-on device mounting structure of FIG. 11 installed in a toolbox of a vehicle and a hang-on device fastened to the connectors of the connection devices of the hang-on device mounting structure.

### DETAILED DESCRIPTION OF THE PREFERRED EMBODIMENT

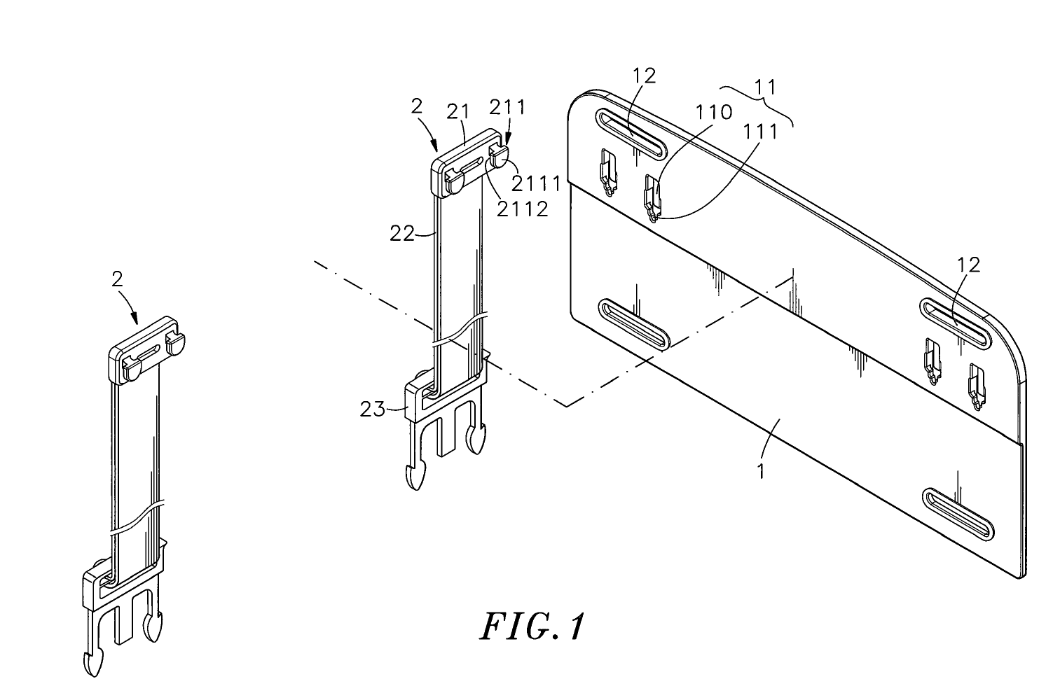

Referring to FIGS. 1˜3, a hang-on device mounting structure in accordance with the present invention comprises at least one base panel 1 and at least one connection device 2.

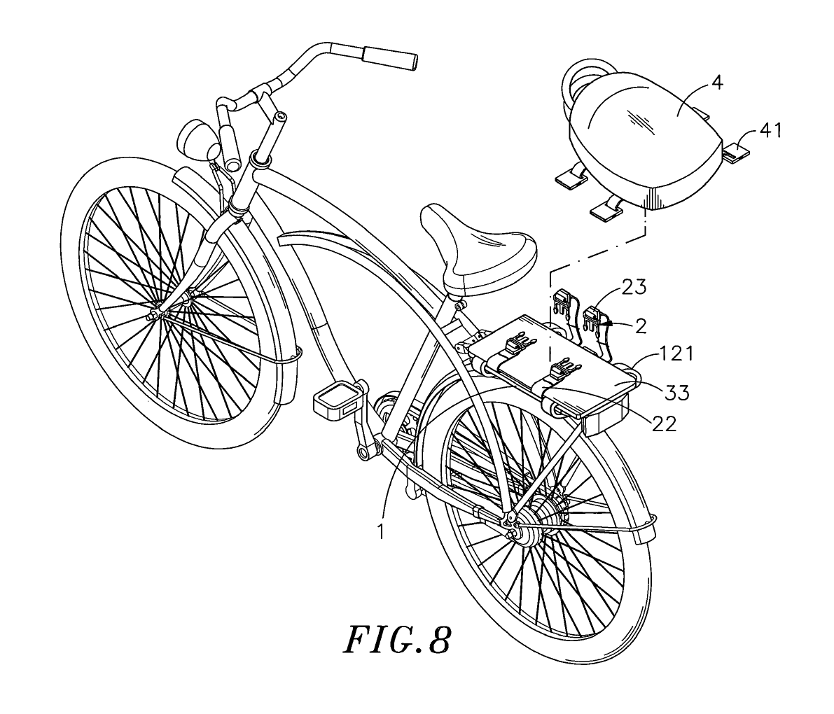

The base panel 1 is a flat sheet member having at least one positioning unit 11 and a plurality of insertion slots 12 spaced around the at least one positioning unit 11 for the insertion of belt members 121 (see FIG. 8). Each positioning unit 11 includes two elongated through holes 110 and a narrow elongated locating notch 111 respectively downwardly extended from the bottom end of each of the two elongated through holes 110. The narrow elongated locating notch 111 has a width smaller than the width of the elongated through holes 110.

The connection device 2 comprises a mounting member 21 for fastening to one positioning unit 11 of the base panel 1, a connector 23, and an extension member 22 connected between the mounting member 21 and the connector 23. The mounting member 21 has two coupling rods 211 protruded from one side thereof for insertion through the two elongated through holes 110 of one positioning unit 11 of the base panel 1 respectively. Each coupling rod 211 has a head 2111 and a neck 2112 connected between the head 2111 and the mounting member 21. The head 2111 is insertable through one elongated through hole 110 of the base panel 1. However, the diameter (or transverse width) of the head 2111 is greater than the transverse width of the narrow elongated locating notch 111. The neck 2112 has a transverse width approximately equal to or relatively smaller than the width of the narrow elongated locating notch 111.

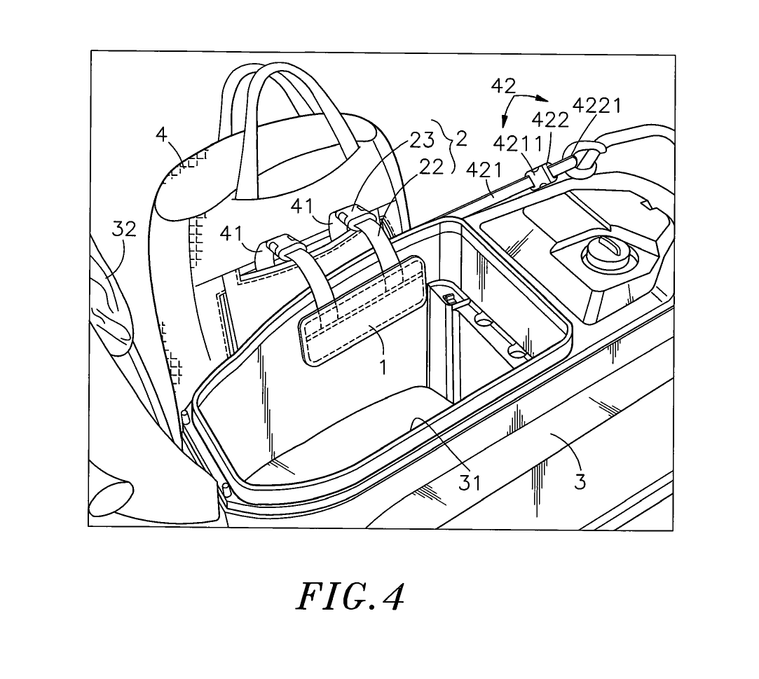

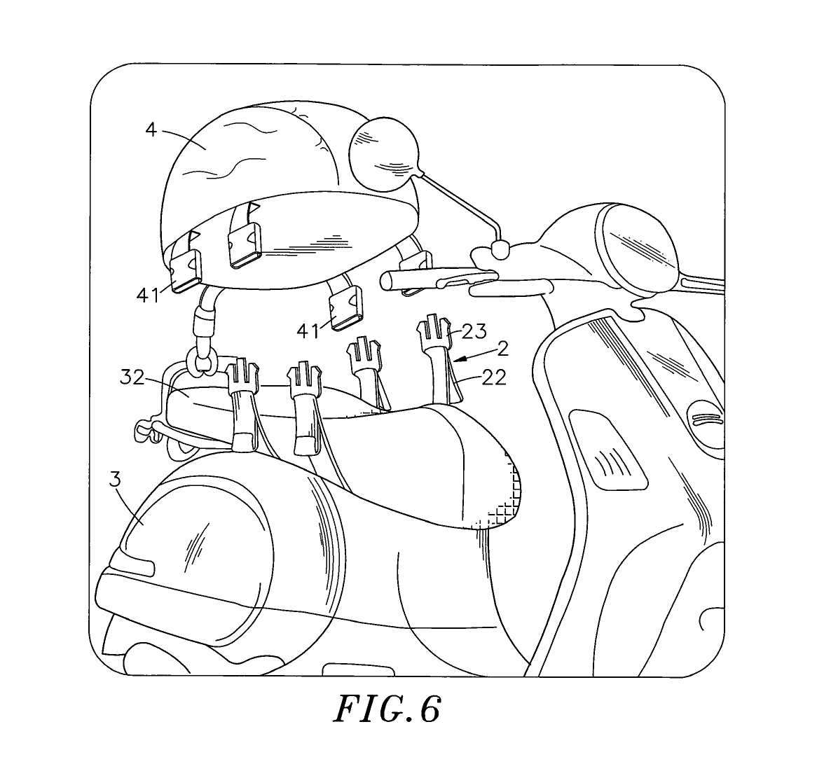

During installation, the mounting member 21 of each connection device 2 is fastened to one positioning unit 11 of the base panel 1 by means of inserting the heads 2111 of the coupling rods 211 through the elongated through holes 110 of the respective positioning unit 11 of the base panel 1 and then lowering the respective connection device 2 to force the necks 2112 of the respective coupling rods 211 into the respective narrow elongated locating notches 111 of the respective positioning unit 11 of the base panel 1. After connection of the connection devices 2 to the positioning units 11 of the base panel 1, a hang-on device 4 can be then fastened to the connectors 23 of the connection devices 2 (see FIGS. 4, 5 and 6).

The aforesaid hang-on device 4 can be a backpack, shoulder bade, carry-on bag, suitcase, water bottle, safety helmet or sea bag.

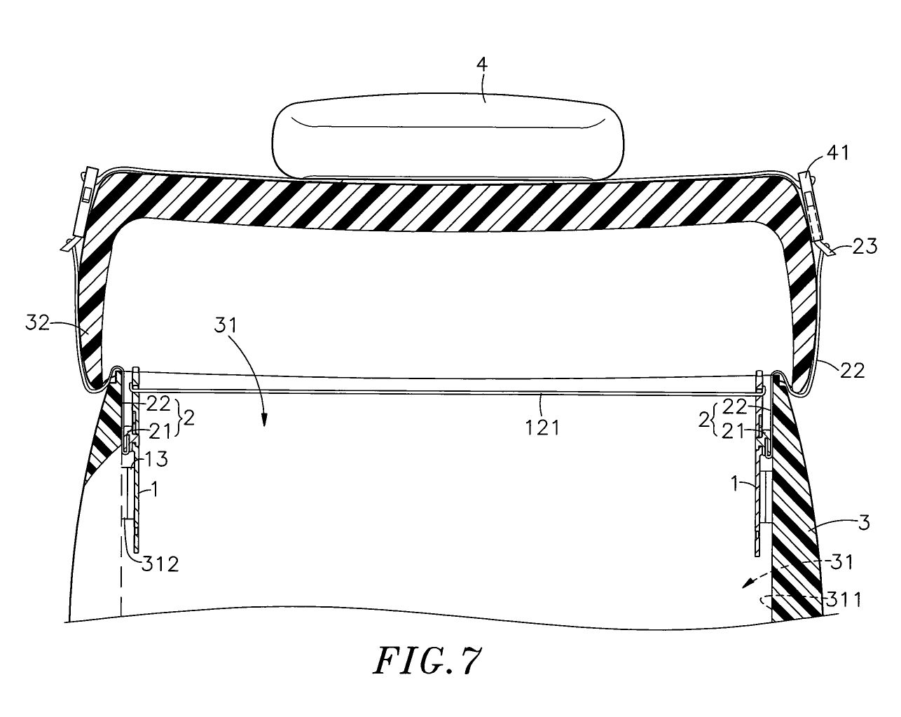

Referring to FIGS. 4, 5, 6 and 7, the base panel 1 can be inserted into the inside of the toolbox 31 of a vehicle 3, for example, a motorcycle or bicycle. After closed the seat 32 of the vehicle 3, the seat 32 holds the base panel 1 firmly inside the toolbox 31, allowing the extension members 22 of the connection devices 2 to be extended to the outside of the toolbox 31 so that matching connectors 41 of a hang-on device 4 can be fastened to the connectors 23 of the connection devices 2. Thus, the hang-on device 4 is hung on the seat 32 of the vehicle 3, and will not be forced to swing during running of the vehicle 3, assuring riding safety. The vehicle 3 can be a motorcycle or bicycle. Binding straps may be inserted through the insertion slots 12 of the base panel 1 to secure the base panel 1 to the seat 32 of the vehicle 3.

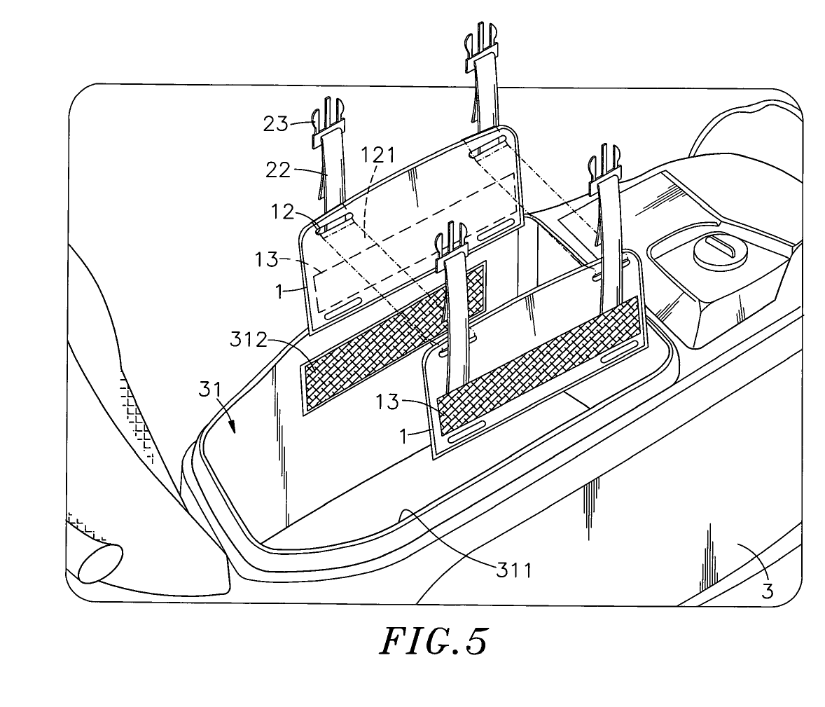

Referring to FIGS. 5, 6 and 7 again, two base panels 1 can be mounted in the toolbox 31 of a vehicle 3 at two opposite sides for securing a hang-on device 4. Further, the base panel 1 can be made having a first fastening element 13 located on the back side thereof for detachably fastening to a respective second fastening element 312 at one lateral sidewall 311 in the toolbox 31 of a vehicle 3. The first fastening element 13 can be a tape of hook materials (or tape of loop materials). The second fastening element 312 can be a tape of loop materials (or tape of hook materials for securing the first fastening element 13. After connection of the first fastening elements 13 of the two base panels 1 to the respective second fastening elements 312 in the toolbox 31 of a vehicle 3, the seat 32 is closed on the toolbox 31, allowing the extension members 22 of the connection devices 2 to be extended to the outside of the toolbox 31 at two opposite lateral sides. At this time, matching connectors 41 of a hang-on device 4 can be fastened to the connectors 23 of the connection devices 2 for enabling the hang-on device 4 to be hung on the seat 32 of the vehicle 3. Further, belt members 121 can be inserted through the insertion slots 12 of the two base panels 1 to join the two base panels 1. After installation, the connectors 41 of the hang-on device 4 impart a pull force to the connection devices 2 and the two base panels 1, and the belt members 121 impart a pull force to the two base panels 1 against the pull force from the hang-on device 4.

Referring to FIG. 4 again, the hang-on device 4 is provided with a fastening device 42 for fastening to the frame structure of the vehicle 3. The fastening device 42 comprises an elastic band 421 fixedly connected to the hang-on device 4 for allowing the hang-on device 4 to be rotated to any desired angle, a first buckle member 4211 fixedly fastened to one end of the elastic band 421 remote from the hang-on device 4, a binding band 4221 fastened to the frame structure of the vehicle 3, and a second buckle member 422 affixed to the binding band 4221 and connectable to the first buckle member 4211.

Further, the aforesaid belt members 121 can be fabric straps, ropes, elastic bands, rubber tapes or rubber rods. The extension member 22 of each connection device 2 can be a fabric straps, ropes, elastic bands, rubber tapes, rubber rods or rubber strips. The connector 23 of each connection device 2 can be a male fastening member (or female fastening member), and each matching connector 41 of the hang-on device 4 can be a female fastening member (or male fastening member) detachably connectable to the male fastening member (or female fastening member) of the connector 23. According to the present invention, a male fastening member can be a male buckle member, hook member, stud or tape of hook materials, and a female fastening member can be a female buckle member, eye member, socket or tape of loop materials for the fastening of the male buckle member, hook member, stud or tape of hook materials.

As stated above, a hang-on device mounting structure according to the present invention comprises at least one base panel 1 mounted inside a toolbox 31 of a vehicle 3 and having at least one positioning unit 11, and at least one connection device 2 each having an extension member 22, a mounting member 21 located on one end of the extension member 22 and connected to one positioning unit 11 of one base panel 1 and a connector 23 located on the other end of the extension member 22 outside the toolbox 31 for connection to a matching connector 41 of a hang-on device 4 to secure the hang-on device 4 to the seat 32 of the vehicle 3 that covers the toolbox 31.

Referring to FIG. 8, each base panel 1 of a hang-on device mounting structure in accordance with the present invention can be affixed to a vehicle's (bicycle's) luggage-carrier 33 for enabling the connector 23 of each connection device 2 of the hang-on device mounting structure to be fastened to one matching connector 41 of a hang-on device 4 to secure the hang-on device 4 to the luggage-carrier 33.

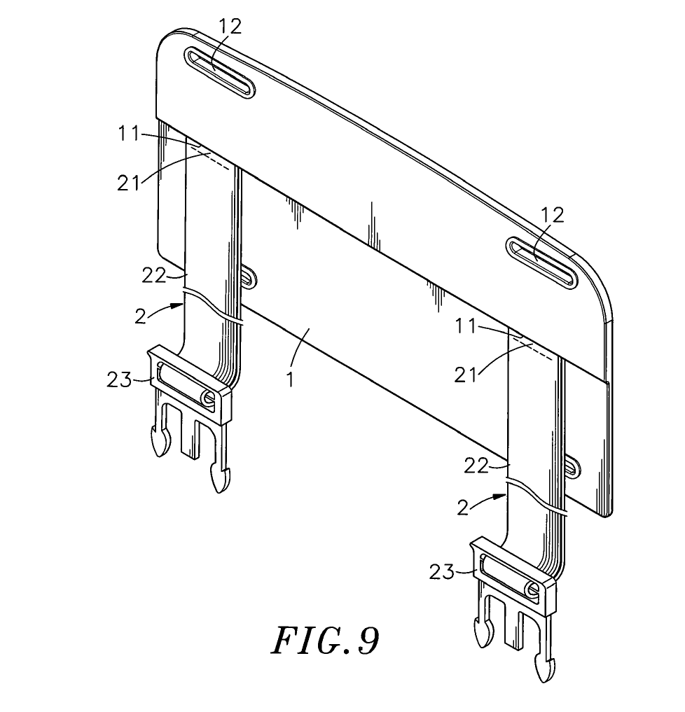

FIG. 9 is a perspective view of a hang-on device mounting structure in accordance with a second embodiment of the present invention. This second embodiment is substantially similar to the aforesaid first embodiment with the exception that the mounting members 21 of the connection devices 2 according to this second embodiment are respectively formed integral with the positioning units 11 of the base panel 1. Because the mounting members 21 of the connection devices 2 are respectively formed integral with the positioning units 11 of the base panel 1, the connection devices 2 have high structural strength against stretching.

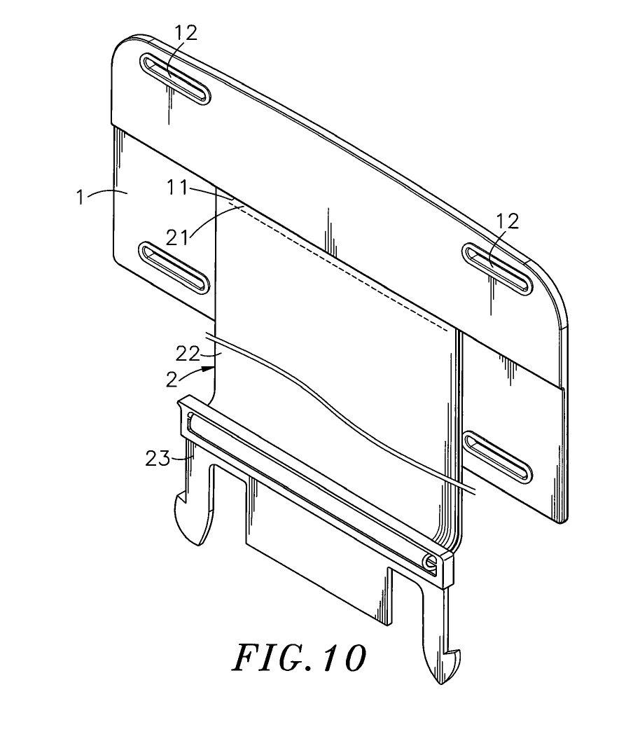

FIG. 10 is a perspective view of another alternate form of the hang-on device mounting structure in accordance with the present invention. According to this embodiment, the mounting member, the mounting member 21 of the connection device 2 is fixedly fastened to the positioning unit 11 of the base panel 1 with stitches or an adhesive.

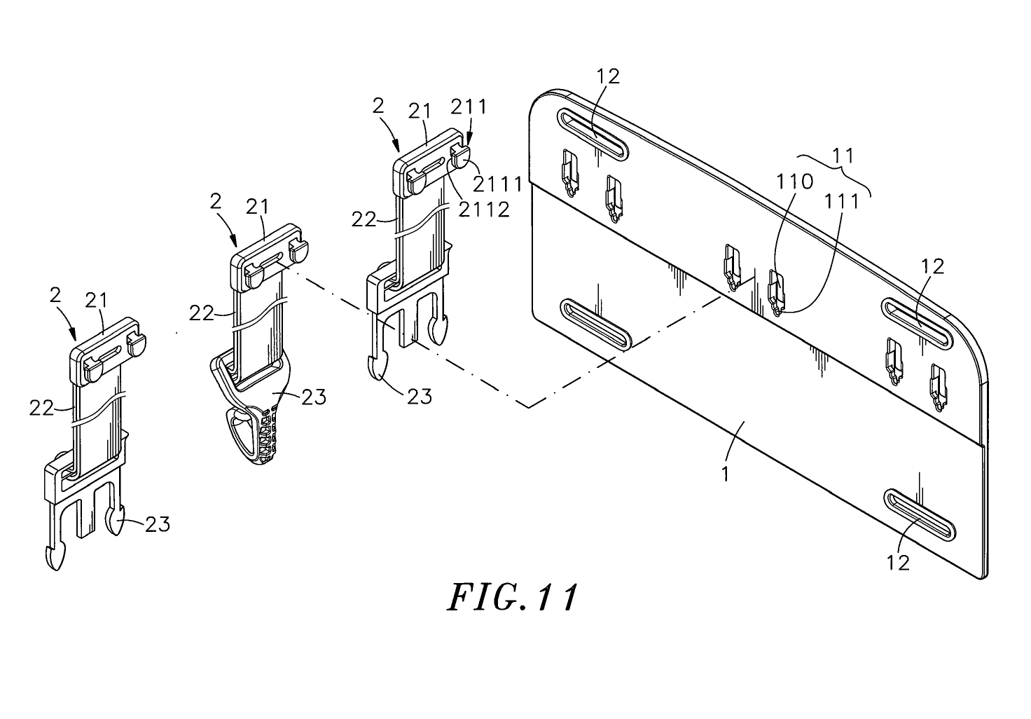

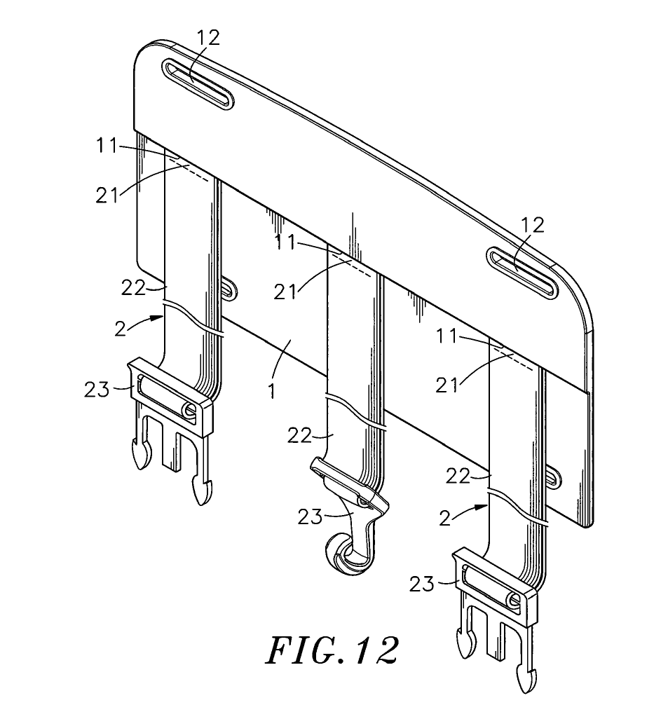

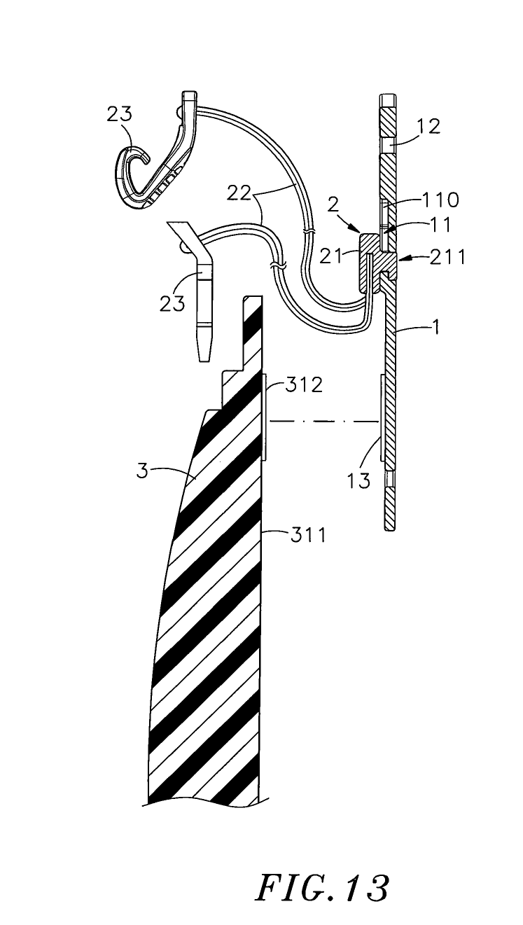

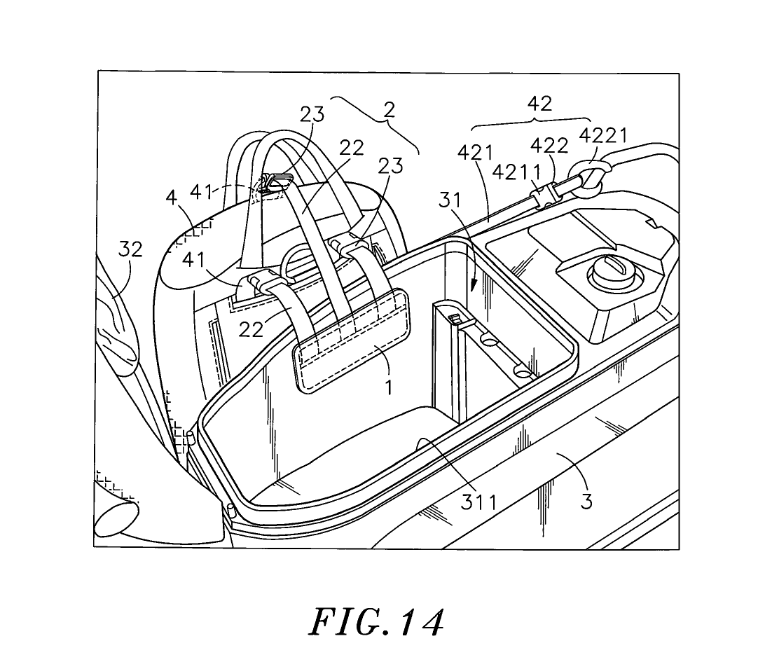

Referring to FIGS. 11, 12, 13 and 14, the hang-on device fastening comprises at least one base panel 1 and at least one connection device 2 for securing a hang-on device 4 to the at least one base panel 1. Each base panel 1 has at least one positioning unit 11 and a plurality of insertion slots 12 spaced around the at least one positioning unit 11 for the insertion of belt members. Each connection device 2 comprises a mounting member 21 for fastening to one positioning unit 11 of one base panel 1, a connector 23 connectable to one matching connector 41 of the hang-on device 4, and an extension member 22 connected between the mounting member 21 and the connector 23. According to this embodiment, the hang-on device mounting structure comprises three connection devices 2. As stated above, the connector 23 of each connection device 2 can be a male fastening member that can be a male buckle member, hook member, stud or tape of hook materials, or a female fastening member that can be a female buckle member, eye member, socket or tape of loop materials. According to this embodiment, the connectors 23 of the two lateral connection devices 2 are male buckle members respectively fastened to the female buckle members of respective matching connectors 41 of the hang-on device 4, and the connector 23 of the middle connection device 2 is a hook member fastened to the eye member of the respective matching connector 41 of the hang-on device 4. Thus, the hang-on device 4 is firmly secured to the vehicle 3 against swinging.

A prototype of hang-on device mounting structure has been constructed with the features of FIGS. 1˜14. The hang-on device mounting structure comprises at least one base panel 1 mounted in a toolbox 31 or luggage-carrier 33 of a vehicle 3 and having at least one positioning unit 11, and at least one connection device 2 each having an extension member 22, a mounting member 21 located on one end of the extension member 22 and connected to one positioning unit 11 of one base panel 1 and a connector 23 located on the other end of the extension member 22 outside the toolbox 31 for connection to a matching connector 41 of a hang-on device 4 to secure the hang-on device 4 to the vehicle 3 against swinging.

In conclusion, the invention provides a hang-on device mounting structure, which has the following advantages and features:

1. By means of mounting at least one base panel 1 in a toolbox 31 or luggage-carrier 33 of a vehicle 3 and then using the at least one connection device 2 to connect a hang-on device 4 to the at least one base panel 1, the hang-on device 4 is firmly secured to the vehicle 3 at one lateral side or held down on the luggage-carrier 33, assuring motorcycle or bicycle rider's riding safety.

2. By means of the hang-on device mounting structure to secure the motorcycle or bicycle rider's personal hang-on device 4 to one lateral side of the toolbox 31 or the top side of the luggage-carrier 33 of the vehicle 3, the motorcycle or bicycle rider does not need to put the personal hang-on device 4 on the front footrest of the vehicle to interfere with resting of the legs on the front footrest, and the toolbox 31 is left unoccupied for storing other things.

3. Each connection device 2 has a mounting member 21 located on one end of the extension member 22 thereof and connected to one base panel 1 and a connector 23 that can be a buckle member or hook member located on the other end of the extension member 22 for connection to one matching connector 41 of a hang-on device 4 to secure the hang-on device 4 in place, keeping the hang-on device 4 in shape.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A hang-on device mounting structure, comprising:
at least one base panel mountable on a vehicle to hold a hand-on device, each said base panel having at least one positioning unit for mounting;
at least one connection device for securing a hang-on device to said at least one base panel, each said connection device comprising a mounting member for fastening to one positioning unit of one said base panel and an extension member extended from sad mounting member to secure a hang-on device.

2. The hang-on device mounting structure as claimed in claim 1, wherein each said positioning unit of each said base panel comprises at least one through hole; the mounting member of each said connection device comprises at least one coupling rod for coupling to the at least one through hole of one said positioning unit.

3. The hang-on device mounting structure as claimed in claim 2, wherein each said positioning unit of each said base panel further comprises a narrow elongated notch extended from one end of each of the at least one through hole thereof; each coupling rod of the mounting member of each said connection device comprises a head insertable through one through hole of one said positioning unit of one said base panel and a neck connected between said head and the respective mounting member for engaging into the narrow elongated notch of the associating positioning unit.

4. The hang-on device mounting structure as claimed in claim 1, wherein each said positioning unit of each said base panel comprises at least one coupling rod; the mounting member of each said connection device comprises at least one through hole for coupling to the at least one coupling rod of one said positioning unit.

5. The hang-on device mounting structure as claimed in claim 4, wherein the mounting member of each said connection device further comprises a narrow elongated notch extended from one end of each of the at least one through hole thereof; each coupling rod of each said positioning unit of each said base panel further comprises a head insertable through one through hole of the mounting member of one said connection device and a neck connected between said head and the respective positioning unit for engaging into the narrow elongated notch of the associating mounting member.

6. The hang-on device mounting structure as claimed in claim 1, wherein the mounting member of each said connection device is fixedly fastened to one positioning unit of one said base panel by stitches.

7. The hang-on device mounting structure as claimed in claim 1, wherein the mounting member of each said connection device is fixedly fastened to one positioning unit of one said base panel by an adhesive.

8. The hang-on device mounting structure as claimed in claim 1, wherein each said base panel has a plurality of insertion slots for the insertion of belt members selected from a group of fabric straps, ropes, elastic bands, rubber tapes and rubber rods.

9. The hang-on device mounting structure as claimed in claim 1, wherein each said connection device further comprises a connector located on an opposite end of the extension member thereof remote from the mounting member of the respective connection device for connection to said hang-device.

10. The hang-on device mounting structure as claimed in claim 9, wherein the extension member of each said connection device is selectively prepared from a group of fabric straps, ropes, elastic bands, rubber tapes and rubber rods.

11. The hang-on device mounting structure as claimed in claim 9, wherein the connector of each said connection device is a male fastening member selected from a group of male buckle member, hook member, stud and tape of hook materials.

12. The hang-on device mounting structure as claimed in claim 9, wherein the connector of each said connection device is a female fastening member selected from a group of female buckle member, eye member, socket and tape of loop materials.

13. The hang-on device mounting structure as claimed in claim 1, wherein each said base panel is selectively mountable in a toolbox/luggage-carrier of a vehicle; each said connection device further comprises a connector located on an opposite end of the extension member thereof remote from the mounting member of the respective connection device for connection to the hang-on device to be carried.
